(19) United States
(12) Patent Application Publication
(10) Pub. No.: US 2023/0129349 A1
(43) Pub. Date: Apr. 27, 2023

(54) RECYCLING LIGHT SYSTEM USING TOTAL INTERNAL REFLECTION TO INCREASE BRIGHTNESS OF A LIGHT SOURCE

(71) Applicant: Optonomous Technologies, Inc., Agoura Hills, CA (US)

(72) Inventors: Kenneth Li, Agoura Hills, CA (US); Andy Chen, Taichung (TW); Yung Peng Chang, Hsinchu (TW)

(21) Appl. No.: 17/910,300

(22) PCT Filed: Nov. 21, 2020
(86) PCT No.: PCT/US2020/061697

§ 371 Date: Sep. 8, 2022

Related U.S. Application Data
(60) Provisional application No. 63/010,544, filed on Apr. 15, 2020.
(60) Provisional application No. 62/987,579, filed on Mar. 10, 2020.

(51) Int. Cl. F21V 7/00; F21V 9/30; G02B 26/00; F21V 5/04

(52) U.S. Cl. CPC F21V 7/0091; F21V 9/30; G02B 26/008; F21V 5/04; F21Y 2115/10

(57) ABSTRACT

A light-recycling light system (LRLS) that, in some embodiments, uses a transparent solid body (also called a lens) with some surfaces having total-internal-reflection (TIR) characteristics, optionally having no reflective coatings, making the system easy to make and low cost. In some embodiments, the lens includes an input face, an output face, and a curved (elliptical or parabolic) side surface that exhibits TIR, wherein the curved side surface defines a first focus at the input face and a second focus at the output face, so recirculating light entering at the first focus and reflecting at one side of the curved surface by TIR toward the second focus, hen reflects at the second focus toward the opposite side of the curved surface, and then reflects at the second side of the curved side surface by TIR toward the first focus. A light source emits light at the first focus.

### CROSS-REFERENCE TO RELATED APPLICATIONS

This application claims priority benefit, including under 35 U.S.C. § 119(e), of
U.S. Provisional Patent Application 62/987,579 titled “Recycling Light System and Lens using Total Internal Reflection to Increase Brightness of a Light Source,” filed Mar. 10, 2020, by Kenneth Li et al.; and
U.S. Provisional Patent Application 63/010,544 titled “Recycling Light System using Total Internal Reflection to Increase Brightness of a Light Source,” filed Apr. 15, 2020, by Kenneth Li et al.; each of which is incorporated herein by reference in its entirety.

This application is related to:—U.S. Provisional Patent Application 62/916,580 titled “Recycling Light System using Total Internal Reflection to Increase Brightness of a Light Source,” filed Oct. 17, 2019, by Kenneth Li;
U.S. Provisional Patent Application 62/763,423 titled “Laser Excited Crystal Phosphor Light Module,” filed Jun. 14, 2018 by Yung Peng Chang et al.,
U.S. Provisional Patent Application 62/764,085 titled “Laser Excited Crystal Phosphor Light Source with Side Excitation,” filed Jul. 18, 2018 by Yung Peng Chang et al.,
U.S. Provisional Patent Application 62/764,090 titled “Laser Excited RGB Crystal Phosphor Light Source,” filed Jul. 18, 2018 by Yung Peng Chang et al.,
U.S. Provisional Patent Application 62/766,209 titled “Laser Phosphor Light Source for Intelligent Headlights and Spotlights,” filed Oct. 5, 2018 by Yung Peng Chang et al.,
P.C.T. Patent Application No. PCT/US2020/037669, titled “HYBRID LED/LASER LIGHT SOURCE FOR SMART HEADLIGHT APPLICATIONS,” filed Jun. 14, 2020 by Kenneth Li et al.,
U.S. Provisional Patent Application 62/862,549 titled “ENHANCEMENT OF LED INTENSITY PROFILE USING LASER EXCITATION,” filed Jun. 17, 2019, by Kenneth Li;
U.S. Provisional Patent Application 62/874,943 titled “ENHANCEMENT OF LED INTENSITY PROFILE USING LASER EXCITATION,” filed July 16, 2019, by Kenneth Li;
U.S. Provisional Patent Application 62/938,863 titled “DUAL LIGHT SOURCE FOR SMART HEADLIGHT APPLICATIONS,” filed Nov. 21, 2019, by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019, by Kenneth Li;
P.C.T. Patent Application No. PCT/US2020/034447, filed May 24, 2020 by Y. P. Chang et al., titled “LiDAR INTEGRATED WITH SMART HEADLIGHT AND METHOD,”
U.S. Provisional Patent Application No. 62/853,538, filed May 28, 2019 by Y. P. Chang et al., titled “LIDAR Integrated With Smart Headlight Using a Single DMD,”
U.S. Provisional Patent Application No. 62/857,662, filed Jun. 5, 2019 by Chun-Nien Liu et al., titled “Scheme of LIDAR-Embedded Smart Laser Headlight for Autonomous Driving,”
U.S. Provisional Patent Application No. 62/950,080, filed Dec. 18, 2019 by Kenneth Li, titled “Integrated LIDAR and Smart Headlight using a Single MEMS Mirror,”
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019, by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019, by Y. P. Chang et al. (published Jan. 23, 2020 as US 2020/0026169);
U.S. patent application Ser. No. 16/509,196 titled “ILLUMINATION SYSTEM WITH HIGH INTENSITY PROJECTION MECHANISM AND METHOD OF OPERATION THEREOF,” filed Jul. 11, 2019, by Y. P. Chang et al. (issued Aug. 25, 2020 as U.S. Pat. No. 10,754,236);
U.S. Provisional Patent Application 62/837,077 titled “LASER EXCITED CRYSTAL PHOSPHOR SPHERE LIGHT SOURCE,” filed Apr. 22, 2019, by Kenneth Li et al.;
U.S. Provisional Patent Application 62/853,538 titled “LIDAR INTEGRATED WITH SMART HEADLIGHT USING A SINGLE DMD,” filed May 28, 2019, by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019, by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019, by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019, by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019, by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019, by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019, by Kenneth Li;
U.S. Provisional Patent Application 62/903,620 titled “RGB LASER LIGHT SOURCE FOR PROJECTION DISPLAYS,” filed Sep. 20, 2019, by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS”; each of which is incorporated herein by reference in its entirety.

U.S. Pat. No. 8,979,308 issued to Li on Mar. 17, 2015 with the title “LED illumination system with recycled light”, and is incorporated herein by reference. U.S. Pat. No. 8,979,308 describes an LED illumination system includes at least one LED element and a recycling reflector having a transmissive aperture through which emitted light passes. The recycling reflector has a curved surface adapted to reflect the impinging light back to the LED element for improved light output through the transmissive aperture.

U.S. Pat. No. 8,858,037 issued to Li on Oct. 14, 2014 with the title “Light emitting diode array illumination system with recycling”, and is incorporated herein by reference. U.S. Pat. No. 8,858,037 describes an LED illumination system includes a plurality of LED modules and a plurality of corresponding collimating lenses to provide increased brightness. Each LED module has at least one LED chip having a light emitting area that emits light and a recycling reflector. The reflector is positioned to reflect the light from the light emitting area back to the LED chip and has a transmissive aperture through which the emitted light exits. The collimating lenses are arranged to receive and collimate the light exiting from the LED modules.

U.S. Pat. No. 8,602,567 issued to Ouyang et al. on Dec. 10, 2013 with the title “Multiplexing light pipe having enhanced brightness”, and is incorporated herein by reference. U.S. Pat. No. 8,602,567 describes multi-color light sources mixed in a recycling housing to achieve high light output. Light from each color light source is multiplexed and a portion of the mixed light passes through an output aperture in the light pipe and a portion light is recycled back, for example, by a shaped reflective surface and/or a reflective coating adjacent the aperture. In one embodiment, the light is directed back from the output side of the housing to an input light source having the same color. In another embodiment, the light is directed back from the output side of the housing to a coating designed to reflect that color. The reflected light is then reflected back toward the output aperture and a portion of that reflected light is again reflected toward the input and impacts the original source for that color light.

U.S. Pat. No. 8,388,190 issued to Li, et al. on Mar. 5, 2013 with the title “Illumination system and method for recycling light to increase the brightness of the light source”, and is incorporated herein by reference. U.S. Pat. No. 8,388,190 describes an illumination system for increasing the brightness of a light source that includes an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 8,317,331 issued to Li on Nov. 27, 2012 with the title “Recycling system and method for increasing brightness using light pipes with one or more light sources, and a projector incorporating the same”, and is incorporated herein by reference. U.S. Pat. No. 8,317,331 describes a recycling system and method for increasing the brightness of light output using at least one recycling light pipe with at least one light source. The output end of the recycling light pipe reflects a first portion of the light back to the light source, a second portion the light to the input end of the recycling light pipe, and transmits the remaining portion of the light as output. The recycling system is incorporated into a projector to provide color projected image with increased brightness. The light source can be white LEDs, color LEDs, and dual paraboloid reflector (DPR) lamp.

U.S. Pat. No. 7,976,204 issued to Li et al. Jul. 12, 2011 with the title “Illumination system and method for recycling light to increase the brightness of the light source”, and is incorporated herein by reference. U.S. Pat. No. 7,976,204 describes an illumination system for increasing the brightness of a light source comprises an optical recycling device coupled to the light source, preferably light emitting diode (LED), for spatially and/or angularly recycling light. The optical recycling device spatially recycles a portion of rays of light emitted by the LED back to the light source using a reflector or mirror and/or angularly recycles high angle rays of light and transmits small angle rays of light, thereby increasing the brightness of the light source's output.

U.S. Pat. No. 7,710,669 issued to Li on May 4, 2010 with the title “Etendue efficient combination of multiple light sources”, and is incorporated herein by reference. U.S. Pat. No. 7,710,669 describes a multi-colored illumination system including a beam combiner. The beam combiner includes two triangular prisms and a filter for transmitting a first light and reflecting a second light, each light having a different wavelength. The beam combiner combines the transmitted first light and the reflected light to provide a combined beam. The six surfaces of each of the triangular prism of the beam combiner are polished, thereby combining the lights without increasing etendue of the multi-colored illumination system.

U.S. Pat. No. 7,232,228 issued to Li on Jun. 19, 2007 with the title “Light recovery for projection displays”, and is incorporated herein by reference. U.S. Pat. No. 7,232,228 describes a light-recovery system for a projection display with a reflector having a first and a second focal points. A source of electro-magnetic radiation is disposed proximate to the first focal point of the reflector to emit rays of radiation that reflect from the reflector and converge substantially at the second focal point. A retro-reflector reflects at least a portion of the electromagnetic radiation that does not impinge directly on the reflector toward the reflector through the first focal point of the reflector to increase the flux intensity of the converging rays.

It has been shown in the past that reflecting part of the light output of a light-emitting diode (LED) back to the LED itself can increase the brightness of the output. Spherical reflectors and special parabolic reflectors have been used. Both of these configurations require reflective coatings inside a concave surface, which makes such a system costly.

What is needed is an improved system for light recycling.

### SUMMARY OF THE INVENTION

In some embodiments, the present invention includes optical configurations that can be molded from plastic polymer(s) or glass without the need for adding reflective coatings. Instead, total internal reflection with high efficiency is used, allowing the system to be molded, while increasing the brightness through the recycling-light mechanism. In extreme cases, reflective coating on the outside of the molded part is optionally used with the molded part(s) of the present invention, which is much cheaper and easier to fabricate than alternatives that apply reflective coatings to the inside of a recycling cavity.

In some embodiments, the present invention provides a light-recycling apparatus that includes a first transparent solid body (also referred to herein as a lens) that has an input face, an output face opposite the input face, and a first elliptical side surface designed to obtain total internal reflection (TIR), wherein the first elliptical side surface defines a first focus point of the first elliptical side surface on the input face and a second focus point of the first elliptical side surface on the output face, such that light that enters the input face at the first focus point and that reflects at a first side of the first elliptical side surface by TIR toward the second focus point, then reflects, by TIR or mirror reflection, at the second focus point on the output face toward a second side of the first elliptical side surface opposite the first side, and then reflects at the second side of the first elliptical side surface by TIR toward the first focus point. Some embodiments further include a light source placed immediately next to (in some embodiments, immediately under, with respect to the Figures herein) the first focus point at the input surface of the first transparent solid body, such that light output from the light source is coupled into the first transparent solid body through the input surface, wherein light intersecting the first elliptical side surface is then reflected by the first elliptical side surface through TIR, and is converged toward the second focus point at the output surface where that light is then reflected by the output face through TIR to the opposite side of the first elliptical side surface and then recycled back and converged toward the first focus point. In some embodiments, the light source includes one or more light-emitting diodes (LEDs) and/or a phosphor plate that is excited (by light from one or more LEDs or laser diodes) to emit wavelength-converted light into the first transparent solid body.

### BRIEF DESCRIPTION OF THE DRAWINGS

FIG. 1 is a side-view cross-sectional block diagram of a generalized light-recycling light source 101 that takes light from LED or laser-excited phosphor source 112 into solid transparent body 150 having parabolic/elliptical upper portion 153 having total-internal-reflection (TIR) characteristics and cylindrical lower portion 152, recycles a portion of that light back to LED or laser-excited phosphor source 112, and outputs an enhanced amount of light through output aperture 154, according to some embodiments of the present invention.

FIG. 2 is a side-view cross-sectional block diagram of a light-recycling light source 201 that takes light from one or more LEDs or laser-excited phosphor sources 112 into solid transparent body 250 having parabolic/elliptical upper portion 253 that has an outer reflective coating 256, and cylindrical lower portion 252, recycles a portion of that light back to LED(s) or laser-excited phosphor sources 112, and outputs an enhanced amount of light through output aperture 254, according to some embodiments of the present invention.

FIG. 3 is a side-view cross-sectional block diagram of a light-recycling light source 301 that takes light from a plurality of LEDs 312 . . . 315 into solid transparent body 150 having parabolic/elliptical upper portion 153 and cylindrical lower portion 152, recycles a portion of that light back to LEDs 312 . . . 315, and outputs an enhanced amount of light through output aperture 154, according to some embodiments of the present invention.

FIG. 4 is a top-view block diagram of an LED array 401 having a plurality of LEDs 312 . . . 315, according to some embodiments of the present invention.

FIG. 5 is a side-view cross-sectional block diagram of solid transparent body 550 having parabolic/elliptical upper portion 553 having total-internal-reflection characteristics and cylindrical lower portion 552, according to some embodiments of the present invention.

FIG. 6 is a side-view cross-sectional block diagram of a light-recycling light source 601 that takes light from one or more LEDs or laser-excited phosphor sources 112 into solid transparent body 650 having parabolic/elliptical upper portion 653 and cylindrical lower portion 652 and having GOBO pattern(s) 657 between the upper portion 653 and lower portion 652, and which recycles a portion of that light back to LEDs or laser-excited phosphor sources 112, and outputs an enhanced amount of light through output aperture 654, according to some embodiments of the present invention.

FIG. 7A is a side-view cross-sectional block diagram of a light-recycling light source 701 that takes light from a plurality of LEDs 712 into a multipart solid TIR reflector 750 with parabolic/elliptical upper portions 753 and a combined lower portion 752, which recycles a portion of that light back to LEDs 712, and outputs an enhanced amount of light through output apertures 754 into lens array 770, according to some embodiments of the present invention.

FIG. 7B is a top-view block diagram of light-recycling light source 701.

FIG. 8A is a side-view cross-sectional block diagram of a light-recycling light source 801 that takes light from one or more LEDs or laser-excited phosphor sources 112 into solid transparent body 850 having parabolic/elliptical upper reflective portion defined by surface 853 and parabolic/elliptical lower reflective portion defined by surface 852, recycles a portion of that light back to LEDs or laser-excited phosphor sources 112, and outputs an enhanced amount of light through output aperture 854, according to some embodiments of the present invention.

FIG. 8B is a side-view cross-sectional block diagram of a light-recycling light source 802 that uses solid-body TIR reflector 882, according to some embodiments of the present invention.

FIG. 8C is a side-view cross-sectional block diagram of a light-recycling light source 803 that uses solid-body TIR reflector 883, according to some embodiments of the present invention.

FIG. 9 is a side-view cross-sectional block diagram of a light-recycling light source 901 that takes light from one or more LEDs 112 into solid transparent body 950 having parabolic/elliptical upper portion defined by surface 953 and convex top surface output aperture 954 and convex bottom surface 951, recycles a portion of that light back to LED(s) 112, and outputs an enhanced amount of light through output aperture 954, according to some embodiments of the present invention.

FIG. 10 is a side-view cross-sectional block diagram of a light-recycling light source 1001 that takes light from one or more LEDs 112 into solid transparent body 1050 having parabolic/elliptical upper portion 1053 and convex top surface output aperture 1054 and non-optical portion 1070, recycles a portion of that light reflected by TIR at surface 1053 back to LED(s) 112, and outputs an enhanced amount of light through output aperture 1054, according to some embodiments of the present invention.

FIG. 11 is a side-view cross-sectional block diagram of a generalized light-recycling light source 1101 that takes light from one or more LEDs 112 into solid transparent body 1150 having parabolic/elliptical upper portion 1153 having TIR characteristics and cylindrical lower portion 1152, recycles a portion of that light back to LED(s) 112, and outputs an enhanced amount of light 1143 through output aperture 1154 into output lens 1158, according to some embodiments of the present invention.

FIG. 12 is a side-view cross-sectional block diagram of a generalized light-recycling light source 1201 that takes light from one or more LEDs 112 into solid transparent body 1250 having parabolic/elliptical upper portion 1253 having TIR characteristics and cylindrical lower portion 1252, recycles a portion of that light back to LED(s) 112, and outputs an enhanced amount of light through output aperture 1254 into output lens 1255 having hole 1256, according to some embodiments of the present invention.

FIG. 13 is a side-view cross-sectional block diagram of a generalized light-recycling light source 1301 that takes light from one or more LEDs 112 into solid transparent body 1350 having parabolic/elliptical upper portion 1353 having TIR characteristics, an output lens portion 1357 having TIR characteristics for some ray angles and cylindrical lower portion 1352, recycles a portion of that light back to LED(s) 112, and outputs an enhanced amount of light through output lens portion 1357, according to some embodiments of the present invention.

FIG. 14 is a side-view cross-sectional block diagram of a light-recycling light source 1401 that takes light from one or more LEDs 112 into hollow body 1450 having parabolic/elliptical upper portion 1453 with a reflective spot 1458 and parabolic/elliptical lower portion 1452, both upper and lower portions having internal reflective coating(s), recycles a portion of that light back to LED(s) 112, and outputs an enhanced amount of light through collimating output lens 1457, according to some embodiments of the present invention.

FIG. 15 is a side-view cross-sectional block diagram of a light-recycling light source 1501 that takes light from one or more LEDs 112 into hollow body 1550 having parabolic/elliptical upper portion 1553 with a reflective hemisphere 1559 and parabolic/elliptical lower portion 1552, both upper and lower portions having internal reflective coating(s), recycles a portion of that light back to LED(s) 112, and outputs an enhanced amount of light through collimating output lens 1557, according to some embodiments of the present invention.

FIG. 16 is a side-view cross-sectional block diagram of a light-recycling light source design 1601 that uses first ellipsoid reflector 1652 and second ellipsoid reflector 1653, according to some embodiments of the present invention.

FIG. 17 is a side-view cross-sectional block diagram of a light-recycling light source 1701 that has reflector 1750 including first ellipsoid reflector 1752 and second ellipsoid reflector 1753, according to some embodiments of the present invention.

FIG. 18 is a side-view cross-sectional block diagram of a light-recycling light source 1801 that has reflector 1850 that is inverted relative to reflector 1750 of FIG. 17, according to some embodiments of the present invention.

FIG. 19 is a block diagram of a vehicle 1901 that includes a light-recycling light-source system 1910, according to some embodiments of the present invention.

### DETAILED DESCRIPTION OF PREFERRED EMBODIMENTS OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

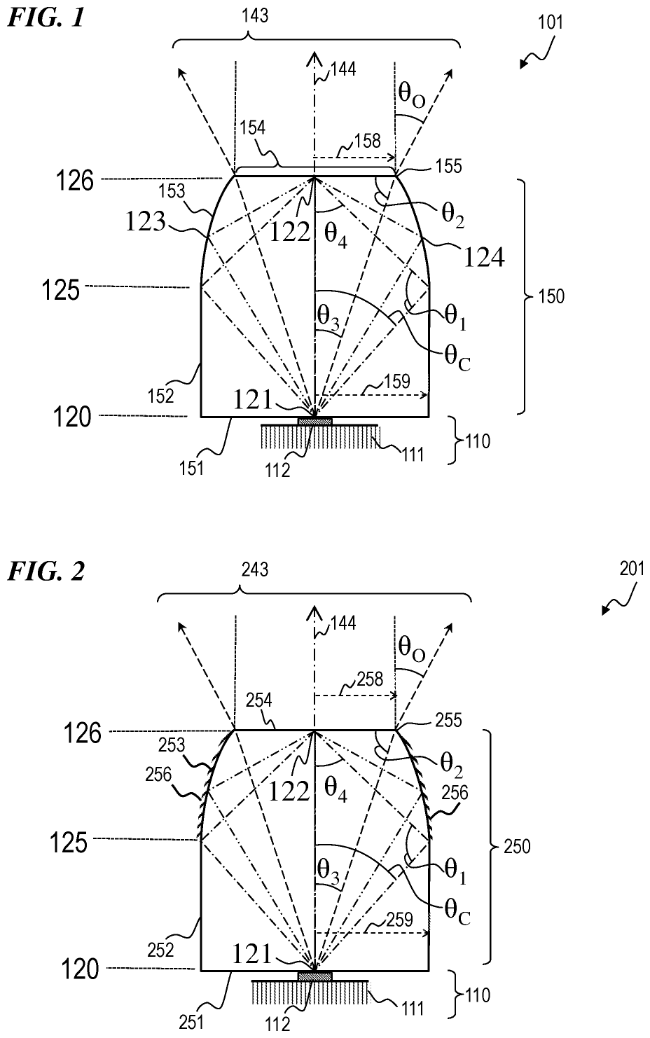

FIG. 1 is a side-view cross-sectional block diagram of a light-recycling light source (LRLS) 101 that takes light from one or more light-emitting diodes (LEDs) or laser-excited phosphor sources 112 into solid transparent body 150 having total-internal-reflection (TIR) characteristics on some surfaces (also referred to as lens 150) that has a parabolic or elliptical upper portion 153 (hereinafter referred to as a parabolic/elliptical upper portion; an elliptical upper portion embodiment is shown in FIG. 1) between height 125 and height 126 (the top surface height) having TIR characteristics, and a cylindrical lower portion 152 having a radius 159 between the “zero” height 120 (the height of bottom surface 151) and height 125 (the height of the intersection of critical angle θ_{C} (the smallest angle of incidence that yields total internal reflection) on the sides of solid-body reflector 150). Solid transparent body 150 is made of a transparent material having a refractive index n. In some embodiments, solid transparent body 150 is molded from one or more plastic polymers (such as acrylic, poly(methyl methacrylate), polycarbonate, polystyrene, cyclic olefin polymer, copolymers of acrylic and polystyrene, and/or the like), while in other embodiments, solid transparent body 150 is molded using glass or other suitable material. One main feature of some embodiments of LRLS 101 is the lack of reflective coatings on solid transparent body 150, making the system easy to make and low in cost. In some embodiments, solid transparent body 150 recycles the portion of LED light that reflects from upper portion 153 by TIR to upper focus point 122, reflects from upper focus point 122 by TIR back to an opposite side of upper portion 153 where the light reflects again by TIR back to LED(s) 112. Solid transparent body 150 outputs a recycling-enhanced amount of light 143 through output aperture 154 having a radius 158 and a circular circumference 155. In some embodiments, LED(s) 112 is/are mounted on a heat sink 111 to together form light source 110, which is placed in contact with the input face 151 of solid transparent body 150 at a first focus point 121, where the light from LED(s) 112 is/are coupled into solid-body reflector 150. When an LED 112 has a common or typical LED-chip light-output profile, the angular light-emission profile is substantially Lambertian, wherein the light spreads zero degrees to ninety degrees from the optical axis 144 (the surface normal vector from the center of the light-output surface of LED 112), which is also the axis of revolution used to form solid-body reflector 150 (which, in some embodiments, is circularly symmetric (having a circular horizontal cross section), while in other embodiments, solid-body reflector 150 may be made to have an elliptical or other suitable cross section). Light from LED 112 enters into the solid-body reflector 150 at an angle between zero degrees (along the optical axis) and ninety degrees from the optical axis (along the bottom surface 151 of solid body 150). The shallowest ninety-degree angle light will be refracted to an internal angle θ_{C}, which is the critical angle governed by the law of refraction. The light between zero degrees (light along the optical axis 144) and the critical angle θ_{C} from the optical axis will be divided into two portions. The portion inside the angle of θ₃ will be coupled through output surface 154 to the outside as a portion of the output light 143 of LRLS 101. The portion of light between θ₃ and the critical angle θ_{C} is reflected by TIR at the elliptical surface 153 defined around the axis of revolution 144 between height 125 and height 126, and that TIR-reflected light is focused at the second focus point 122 on the output surface 154, and is then reflected by TIR to be incident onto the elliptical surface 153 at the opposite side and then reflected by TIR and refocused back to the first focus point 121, where the LED 112 is located. When the refractive index n and the angle θ₃ are chosen appropriately, the two reflections at the elliptical surfaces 153 and the reflection at the output surface 154 will meet the critical-angle-of-incidence criteria for TIR, and thus will have TIR. In this case, the reflections will be 100% and will be theoretically lossless and no reflective coatings on the elliptical surface 153 will be necessary.

In some other embodiments of each of the figures described herein, one or more lasers (e.g., in some embodiments, semiconductor laser diodes) and a laser-excited phosphor plate are substituted for each LED 112. In some embodiments, laser output from a TO-packaged laser is focused onto the phosphor plate using a coupling lens. The phosphor plate converts at least some of the blue light from the laser diode(s) into wavelength-converted visible light that is substantially Lambertian in distribution towards the output direction. To ease the usage of laser-excited phosphor to provide visible light output (e.g., white-light obtained by combining diffused blue laser light and broad-spectrum “yellow” wavelength-converted light from one or more phosphors), the recycling TIR lens (such as shown in FIGS. 1-13) or a hollow-body recycling reflector (such as FIGS. 14-18) is placed at the output of the laser-excited phosphor, converting high-angle output into small-angle output, increasing the brightness of the laser-excited phosphor system. The light-emitting area of the phosphor plate is placed at the first focus of the recycling TIR lens. The output of LRLS 101 will have a smaller divergence angle for coupling to the application system. In one particular embodiment, where a 9-mm-diameter TO-packaged laser is used, the outer diameter is made to be in the 10-mm to 12-mm range, with the outer diameter of the recycling TIR lens in the 10-mm range. In some embodiments, a larger recycling TIR lens is used, as required by the application. In such cases, the lens can be mounted in the application system with the white-light laser module being an independent component, and alignment is performed during the assembly of this module into the system.

In some other embodiments of each of the figures described herein, an excitation LED and an LED-excited phosphor are substituted for each LED 112.

In some embodiments, a plastic high-refractive-index polymer (HRIP) with a refractive index of 1.74 is used for solid-body reflector 150. Such HRIP plastic is commonly used in very thin plastic lenses for eyeglasses. For a practical recycling light system, the output angle (θ_{O}) of 30 degrees is commonly used, giving a recycling ratio of four times (4×). This means that 25% of the light is collected (output) from the system 101 and 75% of the light is recycled. A certain portion of the recycled light will be converted to become a portion of the output light 143, contributing to the extra brightness made possible by LRLS 101. A gain in brightness with a factor of 2.5 to 3.0 can be expected at this recycling ratio for certain white LEDs.

For a refractive index n=1.74 and an output angle (θ_{O}) of 30 degrees, using the law of refraction, θ₃ as shown in FIG. 1 is calculated to be 16.7 degrees and θ₂ to be 73.3 degrees. The critical angle θ_{C} with n=1.74 is 35.1 degrees. Since the angle θ₂ is larger than twice the critical angle θ_{C} (twice the critical angle θ_{C} being 70.2 degrees), total internal reflection occurs at the “B” circumference 155 of height 126. For the other limit at the “A” circumference of height 125, where elliptical surface 153 starts, the angle θ₁ is calculated to be 84.9 degrees, which is also larger than twice the critical angle θ_{C}, and thus the TIR condition is also satisfied. At the output surface 154 of the system 101, the incidence angle θ₄ is calculated to be 71.6 degrees, which is much larger than the critical angle θ_{C} and as a result, TIR will occur at this surface 154 interface for the recirculating rays that reflect from elliptical surface 153. The same output surface 154 also transmits light from the LED 112 at angles less than θ₃ from the optical axis to the output, and as a result, output surface 154 transmits output light and reflects recirculating light at the same time. Choose an elliptical surface with a=20 mm and b=13.4 mm (wherein these “a” and “b” dimensions refer to characteristic parameters of an ellipse used to define surface 153), the radius 159 of the input surface 151 is 13.1 mm, the radius 158 of the output surface 154 is 8.9 mm at the overall height 126 of 29.8 mm at “B” circumference 155 and height 125 is 18.7 mm at the “A” circumference where the elliptical surface 153 starts.

Depending on the dimensions of the LED 112, the dimensions of the LRLS 101 can be designed accordingly. In general, the distances along the light paths between the focus points 121 and 122 and the TIR reflective surfaces of solid transparent body 150 are made many times larger than the dimensions of LED 112, such that imperfections and aberrations are minimized, increasing the efficiency of the LRLS 101. In some embodiments, there is light leakage outside and around the light source 112, which comes from slight aberrations of the optical surfaces of LED 112 and bottom surface 151. The amount of light leakage is to be minimized to provide high efficiency of the system. For the case where upper portion 153 of 150 is parabolic, the collimated light from this parabolic surface is directed towards the opposite parabolic portion of 150, and there is reflected and focused back to focus 121, completing the recycling process. The same parabolic optional embodiment also applies to the subsequent embodiments described below.

FIG. 2 is a side-view cross-sectional block diagram of a light-recycling light source 201 that takes light from LED 112 into solid transparent body 250 having parabolic/elliptical upper portion 253 that has an outer reflective coating 256, and cylindrical lower portion 252, recycles a portion of that light back to LED 112, and outputs an enhanced amount of light 243 through output aperture 254, according to some embodiments of the present invention. In some embodiments, solid transparent body 250 includes a flat input surface 251, and a flat output surface aperture 254 having a radius 258 and a circular circumference 255. Cylindrical lower portion 252 has a radius 259 between the “zero” height 120 (the height of bottom surface 251) and height 125 (the height of bottom of the parabolic/elliptical upper portion 253) of solid-body reflector 250.

Plastic and/or glass of one or more of a plurality of different refractive indices can be used with this configuration. When certain geometrical requirements are needed, in some embodiments, the conditions for reflection may be outside the TIR conditions, and one or more reflective coatings 256 are added to the elliptical surface 253 between height 125 and height 126, as shown in FIG. 2. In certain cases, costs would be increased by adding reflective coating 256, but lower-cost low-index plastic or glass can be used, with the overall cost being lower, for some embodiments.

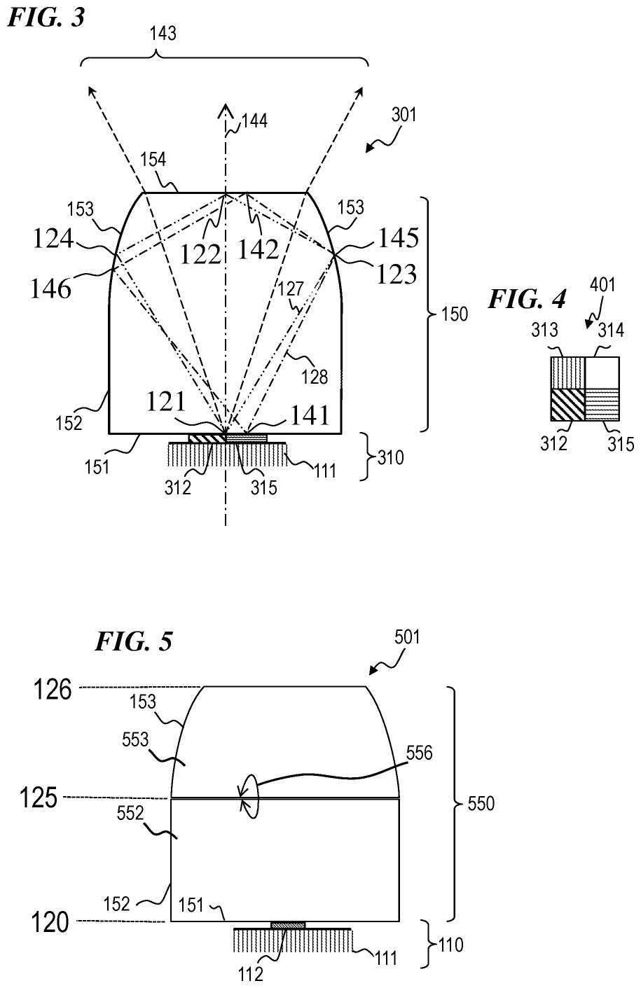

FIG. 3 is a side-view cross-sectional block diagram of a light-recycling light source 301 that takes light from a plurality of LEDs 312 . . . 315 into solid transparent body 150 having parabolic/elliptical upper portion 153 and cylindrical lower portion 152, recycles a portion of that light back to LEDs 312 . . . 315, and outputs an enhanced amount of light 143 through output aperture 154, according to some embodiments of the present invention.

FIG. 4 is a top-view block diagram of an LED array 401 having a plurality of LEDs 312 . . . 315, according to some embodiments of the present invention. In some embodiments, LED array 401 includes a green chip 312, a red chip 313, a white chip 314 and a blue chip 315.

FIG. 3 and FIG. 4 show an embodiment in which a four-chip, red-green-blue-white (RGBW), LED package 401 shown in FIG. 4, is used in the system 301 of FIG. 3. As shown in FIG. 3, certain portions of the light from the center 121 of the input surface 151 follow the optical path 127 (dash-dot-dot line) to 123 on one side of elliptical surface 153, reflect to point 122 at the output surface 154, where it reflects and continues to point 124 at the opposite elliptical surface 153 and reflects back to point 121 at the first focus point 121 at the center of input surface 151. In some embodiments, this recycles light from the center of the plurality of LEDs 312-315 back to portions of all LEDs 312-315. Certain portions of the off-center light, for example starting at point 141 to the right of point 121, follow the optical path 128 (dash-dot line) to point 145 (which coincides with point 123), and due to the different incidence angle, the light of optical path 128 (dash-dot line) will arrive the output optical surface at a position 142 on the right of point 122, and is reflected by TIR at surface 154 towards the opposite elliptical surface 153 at point 146, which is lower than point 124, as shown. Referencing the dash-dot lines joining the two focuses 141 and 142 and point 145 on the right-hand side of elliptical surface 153, it can be seen that the optical path from points 142-to-146 will be reflected to the right-hand side of point 121, arriving at 141, the original point of the dash-dot line 128. This self-imaging property of light-recycling light source 301 allows multi-colored LED packages (as shown in FIG. 4) to be used such that the light from each colored chip will be primarily imaged back to the same-color LED chip, allowing recycling to occur for each chip independent of the others. As a result, this system is suitable for multi-colored LED packages, with brightness increased for each colored chip.

To reduce the Fresnel losses between LED(s) 112 of FIG. 1 (or LEDs 312-315 of FIG. 3) and the system at the input surface 151 where high-angle light from LED 112 (or LEDs 312-315) is being coupled into solid body 150, input surface 151 of some embodiments (not shown) is modified to have slightly concave shape such that, for light emitted at large angles to the optical axis, the angle of incidence is reduced, with a slight lensing effect. In some such embodiments, with a concave surface having a radius of curvature R, molded or polished at the concave-modified input surface 151, LED 112 (or LEDs 312-315) will be positioned slightly above the bottom circumference and the high light-incidence angle at the concave surface will be at less of a glancing angle, allowing lower Fresnel-reflection loss. In addition, in some embodiments, this configuration is very suitable for LEDs made with an integrated dome lens put on top of the LED chips. This protrusion can be easily placed inside the concave-shaped modified input surface 151, increasing the collection efficiency of the system.

Although the above examples are illustrated using high-refractive-index plastic (HRIP) of 1.74, other material with different indices can also be used. High-refractive-index glass can also be used with indices as high as 1.90, producing a light-recycling light source that cannot be achieved using common high-index plastic polymers. This high-index glass is routinely used in Europe for very thin lenses making lightweight eyeglasses.

While reflective coating can be used as needed on the outer surface of the elliptical surfaces, in some embodiments, the outer surface of the input and/or output surfaces are coated with anti-reflective coating. In some embodiments, anti-reflective coating is used to reduce the losses in coupling light from the LED through the input surface 151.

FIG. 5 is a side-view cross-sectional block diagram of solid transparent body 550 having parabolic/elliptical upper portion 553 having total-internal-reflection characteristics and cylindrical lower portion 552, according to some embodiments of the present invention. In some embodiments, to reduce the cost of LRLS 101, solid transparent body 550 is made in two parts (553 and 552), instead of the single solid transparent body 150 of FIG. 1, wherein the upper portion 553 having elliptical surface 153 between height 125 and height 126 is one part and the lower portion 552 having cylindrical surface 152 between height 120 at the input surface 151 and height 125 is the second part. In this case, the high-precision elliptical-surface portion 553 can be made with a smaller total volume, which facilitates molding, and the cylindrical portion 552 can be made with lower-precision molding machines. In some embodiments, the two portions are optically joined together (see curved arrow 556) with glue, heat, or the like, forming a single unit, as shown in FIG. 5. Since the cylindrical portion 552 is not involved in the TIR reflections, instead of using high-index n1 materials, lower-index, lower-cost n2 materials can be used. The lower-angle light entering the elliptical-surface portion 553 from the cylindrical-surface portion 552 will be increased (since more of the high-angle light from LED 112 will enter low-index-of-refraction cylindrical-surface portion 552 (rather than be reflected), and will reach portion 553) as the light enters, allowing TIR to occur at the elliptical-surface portion 553 as designed.

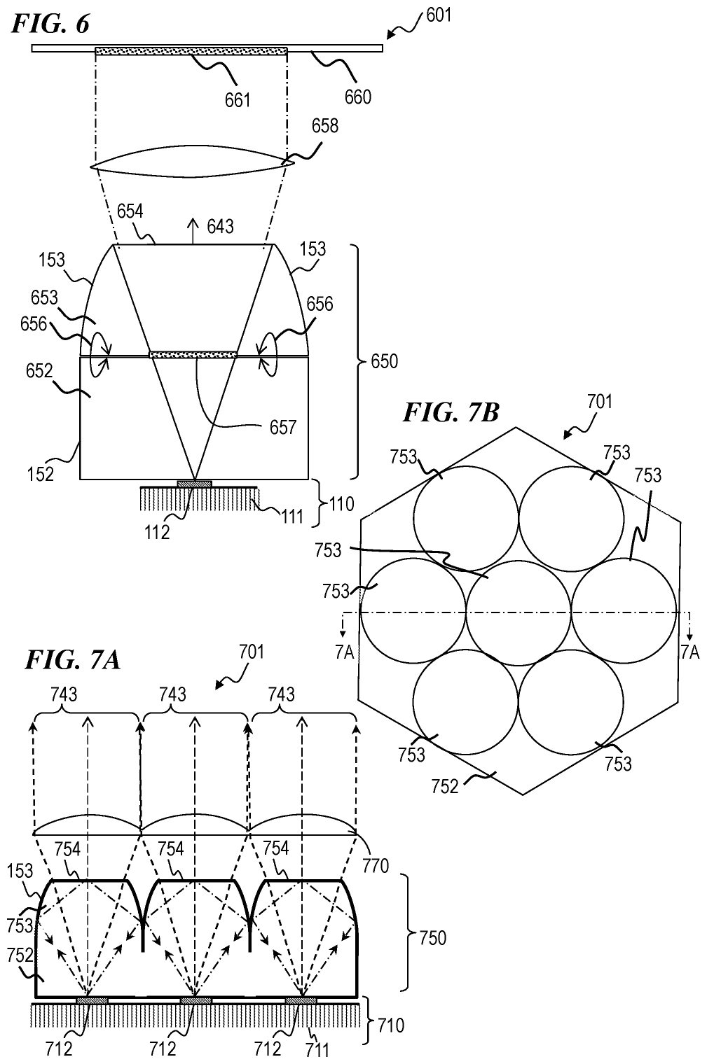

FIG. 6 is a side-view cross-sectional block diagram of a light-recycling light source 601 that takes light from one or more LEDs 112 into solid transparent body 650 having parabolic/elliptical upper portion 653 and cylindrical lower portion 652 and having GOBO (which stands for “goes before optics” {medium.com}) pattern(s) 657 between the upper solid portion 653 and lower solid portion 652. LRLS 601 recycles a portion of LED light via TIR reflections at curved side surface 153, top surface 654, and curved opposite-side surface 153 back to LED(s) 612, and outputs an enhanced amount of patterned light 643 through output aperture 654, according to some embodiments of the present invention. In some embodiments, GOBO pattern 657 is placed at the interface between upper solid portion 653 and lower solid portion 652 with a diameter small enough so as not to block the recycling light paths, as shown in FIG. 6. (A GOBO pattern is a stencil or template placed inside or in front of a light source to control the shape of the emitted light. Lighting designers typically use them with stage lighting instruments to manipulate the shape of the light cast over a space or object—for example to produce a pattern of leaves on a stage floor. {Wikipedia}) Such GOBOs can have patterns of brand names, logos, etc. Depending on the size of the GOBO and the light power, in some embodiments, GOBOs are fabricated from photographic films, printed transparencies, metal templates, or patterns on glass substrates. In some embodiments, projection lens 658 is placed at the output for projecting the GOBO-produced image 661 to the desired location(s) 660. Such GOBO installation into solid transparent body 650 is done easily during the optical-bonding operations 656 that connect parabolic/elliptical upper portion 653 and cylindrical lower portion 652.

FIG. 7A is a side-view cross-sectional block diagram of a light-recycling light source 701 that takes light from a plurality of LEDs 712 into a multipart solid transparent body 750 with a plurality of parabolic/elliptical upper portions 753 each having TIR characteristics and a combined lower portion 752, wherein each respective upper portion 753 recycles a portion of emitted LED light back its respective LED 712, and outputs parallel beams 743, each having an enhanced amount of light, through its output apertures 754 into its respective lens of lens array 770, according to some embodiments of the present invention.

FIG. 7B is a top-view block diagram of light-recycling light source 701.

As shown in FIGS. 7A and 7B, in some embodiments, LRLS system 701 is molded as an array of upper portions 753 combined (during molding, or attached after molding) with a unitary bottom section 752, using bottom section 752 as the connecting platform for the upper portions 753. FIG. 7A shows the cross-section (along section line 7A shown in FIG. 7B) of LRLS system 701, where light source 710 includes an array of LEDs 712 mounted on a heat sink 711. In some embodiments, solid TIR reflector 750 array is molded as a single unit from one material with the bottom portion joined together as a single unit 752, forming a common connected bottom half 752, as shown in FIG. 7B. The individual top portions 753 function independently with regard to their light recycling, as before, and in some embodiments, collimating lens array 770 is molded as a single unit, producing an array of parallel beams 743. FIG. 7B shows an array of seven (7) closely packed LRLS units. In other embodiments, the array is expanded into a larger number of individual recycling units 753 and corresponding lenslets, as needed, forming a very large array for very-high-power applications. In some embodiments, array system 701 is used in high-power spotlight applications and/or light sources for projection displays.

In some embodiments, the LRLS technology described above in FIGS. 1 through 7B is applied to laser-excited-phosphor light sources, that are in place of LEDs 112, for projection displays. The narrowing of output angles effectively lowers the etendue of the laser-excited-phosphor light source system. As a result, the area of the excited phosphor can be made larger for a given etendue value, reducing the issues with cooling and excessive temperature, which otherwise lowers the light-emitting efficiency of the phosphor. In some embodiments, such laser-excited-phosphor light sources include one or more lasers, preferably solid-state semi-conductor lasers that each emit blue light. In some embodiments, the blue laser beam is directed and focused onto a phosphor ring deposited onto a disc, forming a phosphor wheel that rotates at a speed fast enough such that the phosphor on the ring does not burn or overheat, as the area of phosphor on the disc that is excited by the laser is constantly changing. In some embodiments, other coatings, such as selective filters of various wavelengths, are put on top of the phosphor and on the disc such that the conversion efficiency from the laser light into broadband visible light is most efficient. In some embodiments, one or more phosphors absorbing blue pump light and emitting yellow, green, and/or red light are used. In some embodiments, blue light is output either by leaking a predetermined amount of unabsorbed laser light through the phosphor layer, or having an opening or diffuser on one or more portions of the phosphor ring, where blue laser light is output for part of the revolution of the phosphor wheel. The light emitted by the phosphor is normally Lambertian, with wide angle of emission. An LRLS solid transparent body (such as 150, 250, 550, 650 or 750 described above, or 850, 882, 883, 950, 1050, 1150, 1250, 1350, 1450 or 1550 described below) is placed in the proximity of the phosphor where laser excitation occurs. The wide-angle light will enter the LRLS device with part of the light being recycled and combined with the original output light, providing a higher output at a smaller angle. The output is then coupled to a projection engine using an appropriate lens system. In contrast to other collection systems, the LRLS uses total internal reflection (TIR), thus minimizing the loss of the system and at the same time, handling high power without issues with high-temperature degradation and shortened longevity of the reflective coatings in standard systems.

In some embodiments, an array (not shown) of such laser-excited-phosphor systems using LRLS (LEPLRLS) is configured in an array fashion similar to that shown in FIGS. 7A and 7B, wherein each LED 712 of FIG. 7A is replaced by a respective rotating phosphor disc that has a respective laser excitation directly under the respective first focus point of a respective elliptical recycling reflector. In this case, a closely-packed seven-unit array has a common connected bottom portion 752 of the LRLS array with individual top portions 753, each operating independently to recycle light back to the respective location on the phosphor that is excited by the respective laser. An array of seven laser-excited rotating phosphor wheels is placed behind the connected bottom half of the LRLS array, such that each respective phosphor wheel has its respective phosphor ring rotating across the center of the individual respective LRLS where the respective stationary laser excites the phosphor at the input first focus point of individual respective LRLS. Because the rotating discs move different portions of their phosphor to the laser excitation, better heat dissipation is facilitated. The diameters of the phosphor wheels are also adjusted such that all of them fit within the space behind the LEPLRLS array. A larger array with more units can be configured in the same fashion, such that higher power can be obtained without excessive heating of the phosphor elements, which would otherwise lower the efficiency of the system.

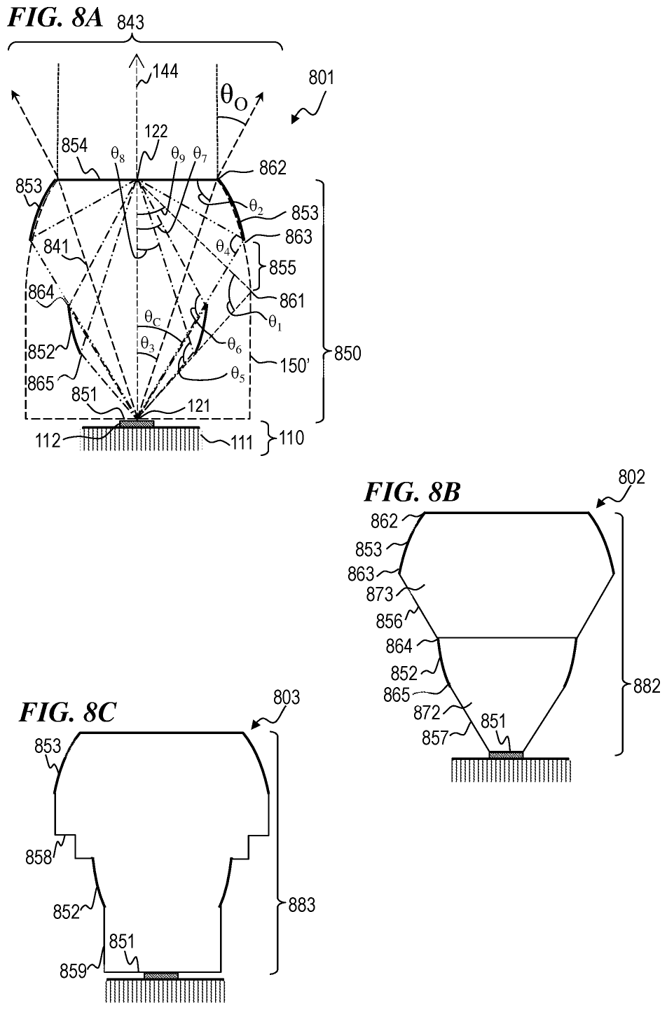

FIG. 8A is a side-view cross-sectional block diagram of a light-recycling light source 801 that takes light from one or more LEDs 112 into solid transparent body 850 having a relatively low index of refraction and a parabolic/elliptical upper reflective portion 853 that recycles TIR-reflected light from portion 853 back to LED(s) 112, and parabolic/elliptical lower reflective portion 852 that reflects light using TIR from that portion 852 through surface 854 to the output light 843, and outputs a recycle-enhanced amount of light (that portion of the light-source light emitted upwards between the two dashed lines 841) through output aperture 854, according to some embodiments of the present invention. When using low-index materials, e.g., low-cost plastic, the refractive index is typically in the range of 1.5. With such a low index-of-refraction transparent material, the critical angle θ_{C} here is smaller than in FIG. 1, so there are areas (area 855 between circumference 861 and circumference 863) of the LED light emission where the critical angles are not reached and TIR will not happen. To resolve this, some embodiments add reflective coatings, as described for FIG. 2 above, but those coatings add cost to the system. While θ₂ may be larger than twice the critical angle, θ₄ is smaller than the critical angle, and light would be lost out through area 855 without a reflective coating on area 855. There is a certain circumference 863 between circumference 861 and circumference 862, where the angle θ₄ is at exactly twice the critical angle, and the region 855 between circumference 861 and circumference 863 will not support TIR if the original shape 150′ (in the outermost dashed lines, corresponding to shape 150 of FIG. 1) were used, and more light would be lost. In order to capture some of the otherwise-lost light and put it back to the output of the LRLS 801, a second curved surface 852 is introduced to maintain TIR at higher-angle LED-emission regions, as shown in FIG. 8A.

While surface 853 and region 855 are from the previous design shape 150 shown in FIG. 1, the new surface 852 is introduced in FIGS. 8A, 8B and 8C, reflecting the light that would have been lost through area 855 (shown in FIG. 8A) between circumference 861 and circumference 863 of the original design (i.e., the original design shown by light dashed line 150′) to the output surface 854. θ₁ and θ₉ of FIG. 8A correspond to θ₁ and θ₄ of FIG. 1. The location of surface 852 is closer to the axis of revolution 144, making the angles θ₅ and θ₆ larger than twice the critical angle, allowing total internal reflection on surface 852. The interior of surface 852 facing the LED light is concave and preferably elliptical such that surface 852 has the same focus points 121 and 122 as the surface 853. In some embodiments, elliptical surface 852 extends starting at input surface 851 and going all the way up to circumference 863. It is also noted that, in some embodiments, θ₇ and θ₈ will be larger than the critical angle, allowing TIR at the output surface. In some embodiments, reflective surface 852 is between circumference 864 and circumference 865. In some embodiments, the critical reflective surfaces 852, 853 and 854 of the LRLS 801 (shown as heavy solid lines, with the rest of the connecting surfaces shown as dash-dot lines) can be designed to facilitate the molding of part 850 of assembly of LRLS 801, lowering the cost, etc., as long as they do not block the useful light, and in some embodiments, the surface profiles between circumference 863 and circumference 864 are made to form a step such as step 858 and/or step 859 shown in FIG. 8C. This step can be used for assembly into various devices such as flashlights, spotlights, etc.

FIG. 8B is a side-view cross-sectional block diagram of a light-recycling light source 802 that uses solid-body TIR lens 882, having two elliptical TIR reflectors 853 and 852 as described above for FIG. 8A, and that has tapered side portion 856 between TIR reflectors 853 and 852, and has tapered side portion 857 between TIR reflector 852 and input face 851. The design of the system also allows breaking the system down into multiple pieces due to mold sizes, etc., such that the overall cost can be made lower. For example, in some embodiments, one piece of transparent material 873 is made between circumference 862 and circumference 864 and the other piece 872 (optionally having a different index of refraction) is made between the input surface 851 and circumference 864. Other circumferential locations can also be chosen, such as circumference 863, as design and cost restrictions may dictate.

FIG. 8C is a side-view cross-sectional block diagram of a light-recycling light source 803 that uses solid-body TIR lens 883, having two elliptical TIR reflectors 853 and 852 as described above for FIG. 8A, and that has stepped cylindrical side portion 858 between TIR reflectors 853 and 852, and has stepped cylindrical side portion 859 between TIR reflector 852 and input face 851.

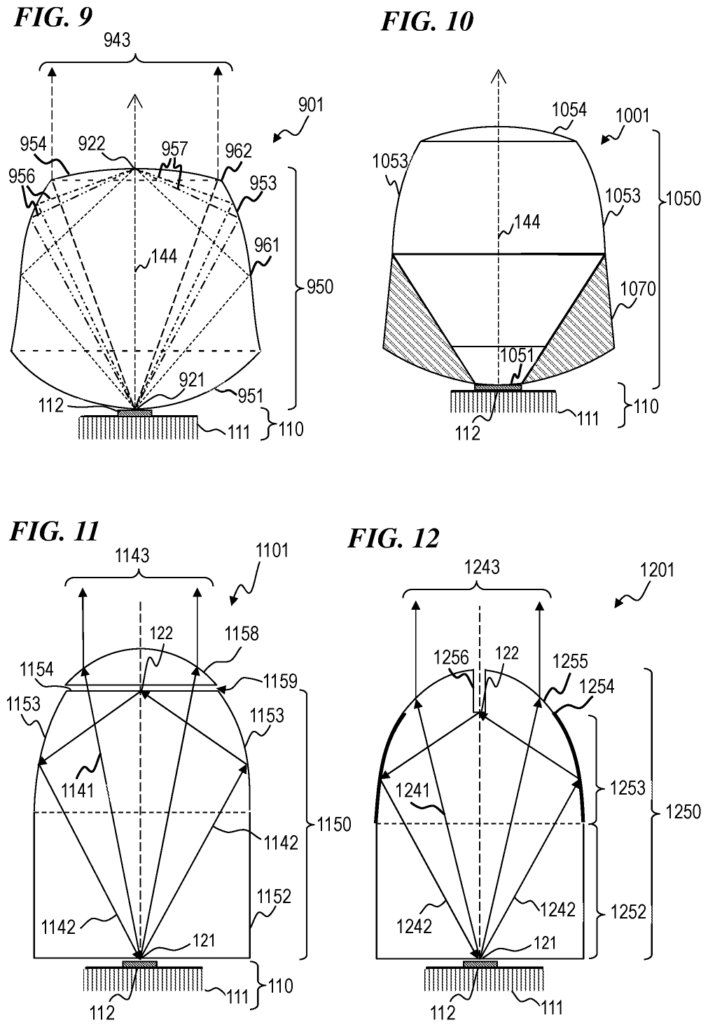

In other embodiments of this invention, the planar input and output surfaces of the previous embodiments, such as surfaces 151 and 154 of FIG. 1, are replaced by convex surfaces at the top, at the bottom, or both, such as surfaces 951 and 954 shown in FIG. 9, which shows an embodiment where both the output and input surfaces are convex and can be optimized to provide the maximum output efficiency and recycling efficiency, with minimum loss.

Continuing, FIG. 9 is a side-view cross-sectional block diagram of a light-recycling light source 901 that takes light from one or more LEDs 112 into solid transparent body 950 (also referred to as lens 950) having TIR characteristics on some surfaces, with parabolic/elliptical upper portion 953, convex top surface output aperture 954, and convex bottom surface 951. One or both the top surface 954 and bottom surface 951 can be flat or convex, i.e., flat-flat, flat-convex, convex-flat, or convex-convex. In some embodiments, lens 950 recycles a portion of that light back to LED(s) 112, and outputs an enhanced amount of light 943 through output aperture 954. The light source 112 is placed immediately next to the bottom surface 951, at the first focus 921 of the elliptical surface 953, such that the output from the light source 112 is coupled into the lens 950 through the convex surface 951. The recycling light 956 is then reflected by the elliptical surface 953 through TIR, or from a design-optimized free-form surface (i.e., a non-elliptical surface designed using optics software, not shown) and is converged to the second focus 922, at the top convex surface 954. The recycling light 956 is then reflected through TIR as recycling light 957 towards elliptical surface 953 on the opposite side of the lens 950 and is then converged towards the first focus 921 for recycling (by impinging on light source 112 and being scattered and reflected back into lens 950). The rest of the light-source output that is output at a smaller output angle (i.e., at a smaller angle than the angles of the portion of light used by the TIR surface 953 for recycling) is coupled to the output 943 through the top convex surface 954. The recycled light incident onto the light source will then be scattered and reflected—with part of the light recycled again and part of the light coupled to the output 943, increasing the total output of the system. The process repeats with further increase in output, contributing to the gain of the recycling system 901.

As shown by the ray-tracing diagram of FIG. 9, part 1070 of the lens 1050 shown in FIG. 10 is not used optically, as light entering the lens will be refracted at a smaller input angle relative to optical axis 144 by the convex bottom surface 1051 as compared to the large-angle light emitted from the LED in air. This non-optical section 1070 can be removed totally to reduce the size and cost of the lens. Alternatively, in some embodiments, non-optical section 1070 is designed with mechanical functions (such as one or more of the step shapes of FIG. 8C) such that it can be mounted onto other components with simplicity and low cost.

FIG. 11 is a side-view cross-sectional block diagram of a generalized light-recycling light source 1101 that takes light from one or more LEDs 112 into solid transparent body 1150 having parabolic/elliptical upper portion 1153 having TIR characteristics and cylindrical lower portion 1152, recycles a portion of that light back to LED(s) 112, and outputs an enhanced amount of light 1143 through output aperture 1154 into output lens 1158, which further extends the present invention to embodiments with collimated beams. LRLS 1101 is an embodiment where output collimation lens 1158 is added to the output of the TIR lens 1150, such as lens 150 shown in FIG. 1. In some embodiments, output lens 1158 is integrated together with the TIR lens unit mechanically (such a mechanism not shown in FIG. 11), leaving an air gap 1159, or using a low-index glue in gap 1159 such that the TIR characteristics are preserved for recycling light 1142 at the second focus point 122. With such an output lens 1158, the output half angle can be made smaller, in the range of a few degrees (e.g., in some embodiments, 3.5 degrees), depending on the dimensions of the light source 110. Besides collimation, in some embodiments, output lens 1158 is designed to provide any output angle desired, including divergence output light patterns.

FIG. 12 is a side-view cross-sectional block diagram of a generalized light-recycling light source 1201 that takes light from one or more LEDs 112 into solid transparent body 1250 having parabolic/elliptical upper portion 1253 having TIR characteristics and cylindrical lower portion 1252, recycles a portion of that light back to LED(s) 112, and outputs an enhanced amount of light 1243 through output aperture 1254 into output lens portion 1255 having hole 1256. To integrate the system further, in some embodiments, output lens surface 1255 as shown in FIG. 12 is designed to be collimating, diverging, etc., to the desired output angles. The flat bottom of the small hole 1256 in the output lens section 1255 of the integrated TIR lens 1250 is placed at the second focus point 122 location, where the TIR of the recycling light 1242 is desired, with the required radial dimensions of the spot size to provide a sufficient area for the TIR reflection of recycled light 1242. In some embodiments, hole 1256 is simply empty (i.e., filled with air), or in other embodiments, filled with low-index optical fillers such as epoxy, acrylic, or the like. The key is to allow TIR at the bottom of the hole 1256 for light recycling.

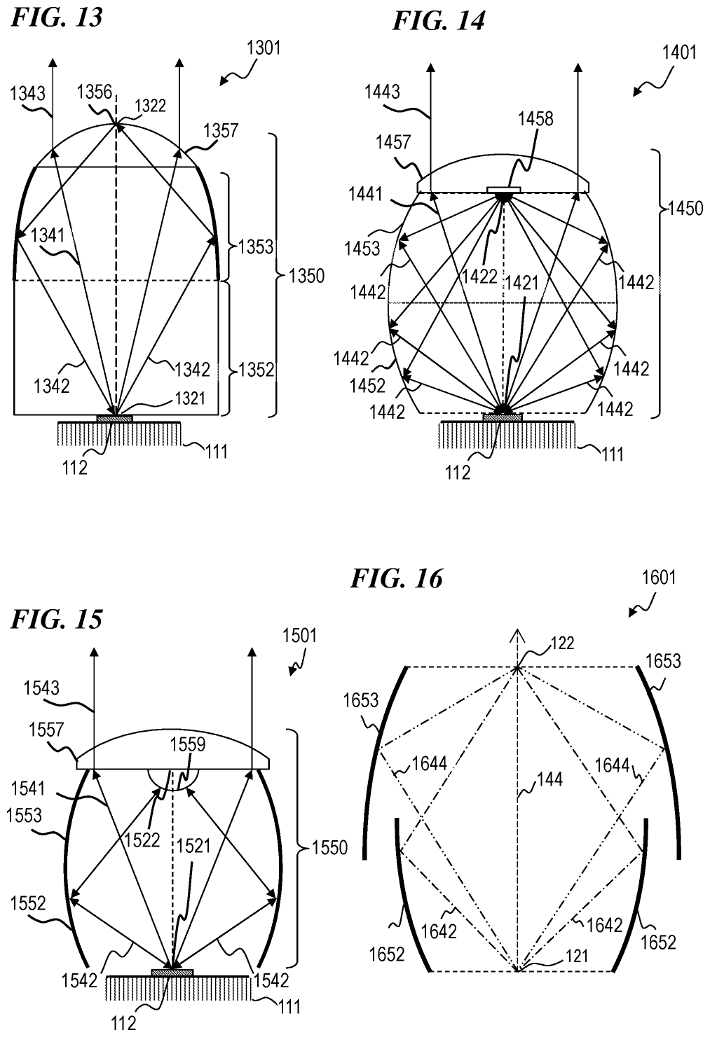

FIG. 13 is a side-view cross-sectional block diagram of a generalized light-recycling light source 1301 that takes light from one or more LEDs 112 into solid transparent body 1350 having parabolic/elliptical upper portion 1353 having TIR characteristics, an output lens portion 1357 having TIR characteristics for some ray angles, and cylindrical lower portion 1352, recycles a portion of that light back to LED(s) 112, and outputs an enhanced amount of light 1343 through output lens portion 1357, where the TIR surface 1356 for the recycling beam 1342 is designed to match to the center of the surface of output lens 1357 and to focus point 1322, such that a hole is not needed. Such a design requires modification of the elliptical surface 1353 such that the second focus point 1322 is at the center 1356 of the surface of output lens 1357. In some embodiments, output lens portion 1357 and elliptical upper portion 1353 and cylindrical lower portion 1352 are molded from a single piece of transparent material, while in other embodiments, two or three pieces are separately molded (optionally having two or three respective different indices of refraction) and then optically bonded to one another. In some embodiments, TIR lens 1350 is also designed to provide output divergences from a very small angle, to a larger angle, or any other angles, using convex and/or concave surface portions as the output lens 1357 surface.

FIG. 14 is a side-view cross-sectional block diagram of a light-recycling light source 1401 that takes light from one or more LEDs 112 into hollow body 1450 having interior parabolic/elliptical upper portion 1453, a reflective mirror 1458 and parabolic/elliptical lower portion 1452, both upper and lower portions having interior reflective coatings, recycles a portion 1442 of that light back to LED(s) 112, and outputs an enhanced amount of light 1443 through collimating output lens 1457. Such embodiments may meet certain system requirements where a solid TIR lens is not applicable. In some such embodiments, a hollow elliptical reflector 1450 as shown in FIG. 14 (or 1550 of FIG. 15) is placed such that the first focus 1421 is at the light source 112 and a mirror 1458 is placed at the reflective spot at the second focus 1422. All the rays from the light source will either be reflected by the elliptical reflector 1450 or exit the system as the output beam 1443. The LED light reflected by elliptical surface 1453 or elliptical surface 1452 will be focused at 1422 and then reflected back to the LED at 1421 for recycling. In some other embodiments, surfaces 1452 and 1453 are parabolic in shape such that light from LED 112 that is reflected by surface 1452 is reflected as parallel rays and then reflected by surface 1453 to second focus point 1422 and reflected by mirror 1458 back to the opposite sides of hollow body 1450 and back to LED 112 for recycling.

FIG. 15 is a side-view cross-sectional block diagram of a light-recycling light source 1501 that takes light from one or more LEDs 112 into hollow body 1550 having parabolic/elliptical upper portion 1553 with a reflective hemisphere 1559 and parabolic/elliptical lower portion 1552, both upper and lower portions 1553 and 1552 having total interior reflective coatings, recycles a portion 1542 of the LED light back to LED(s) 112, and outputs an enhanced amount of light 1543 through collimating output lens 1557, according to some embodiments of the present invention. In this embodiment, the flat mirror 1458 of FIG. 14 at the second focus point 1422 of FIG. 14 is replaced by a reflective hemisphere 1559 in FIG. 15. In some embodiments, light enters at focus point 1521, and recycling rays 1542 incident towards second focus point 1522 are reflected backwards to the same side of elliptical reflector 1550, following the same path from the LED 112 in the opposite direction back to LED 112 itself at focus point 1521 for recycling, rather than being reflected to the opposite side of the elliptical reflector as is the case in the embodiment of FIG. 14. This has an advantage that the surface area of the hemisphere is much larger than the focused spot at 1522 and allows higher-power operation with lower power density at the reflective surface.

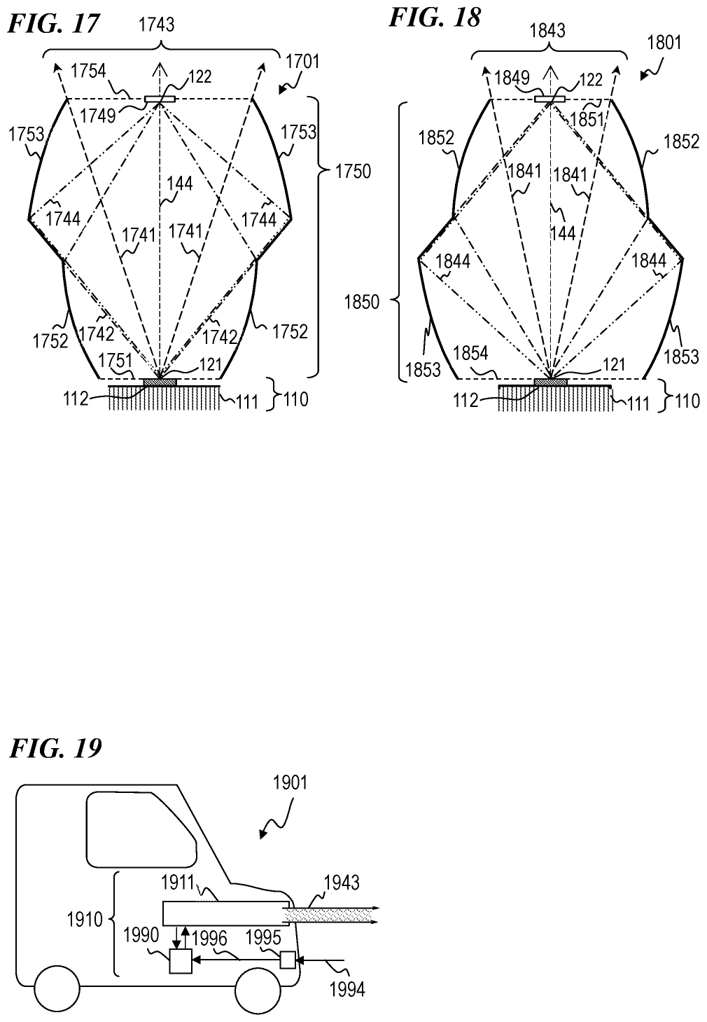

FIG. 16 is a side-view cross-sectional block diagram of a light-recycling light source design 1601 that uses first ellipsoid reflector 1652 and second ellipsoid reflector 1653, wherein reflectors 1652 and 1653 are based on unequal ellipsoids that share common foci, i.e., focus 121 and focus 122. Light that is emitted or reflected from one focus 121 or 122 and that is reflected by either ellipsoid 1652 or ellipsoid 1653 will be directed at the other focus 122 or 121, as shown. For example, light shown as exemplary dash-dot line 1642 from focus 121 or 122 is reflected by ellipsoid 1652 toward opposite focus 122 or 121, respectively, and light shown as exemplary dash-dot-dot line 1644 from focus 121 or 122 is reflected by ellipsoid 1653 toward the opposite focus 122 or 121, respectively. In some embodiments, design 1601 is used for hollow-body reflectors such as shown in FIG. 17 and FIG. 18.

FIG. 17 is a side-view cross-sectional block diagram of a light-recycling light source system 1701 that uses first hollow ellipsoid reflector 1752 and second hollow ellipsoid reflector 1753, used in a light-recycling configuration. In some embodiments, light source 112 includes one or more LEDs, while in other embodiments, light source 112 includes one or more laser-excited phosphors excited by one or more lasers. In some embodiments, light source 112 is placed at focus 121 of system 1701 and a small mirror reflector 1749 is placed at focus 122 of system 1701 such that the upward-propagating light focused by ellipsoid reflectors 1753 and 1752 at the reflector 1749 is reflected toward to the opposite side of the ellipsoid reflectors 1753 and 1752. Part of the light output of light source 112 (that portion between a horizontal plane 1751 at the top light source 112 and the lower dash-dot lines 1742 of FIG. 17) is reflected by the ellipsoid reflector 1752 toward reflector 1749 at focus 122, where that light is reflected back to the opposite side of ellipsoid reflector 1752, then back to LED 112 at focus 121 and recycled. Another part of the output of light source 112 (that portion between lower dash-dot-dot lines 1744 and the upper edge of ellipsoid reflector 1753 of FIG. 17) will be reflected by ellipsoid reflector 1753 toward reflector 1749 at focus 122, where that light is reflected back to the opposite side of ellipsoid reflector 1753, then back to LED 112 at focus 121 and recycled. The small-angle light (that portion of light emitted upwards from light source 112 between the two dashed lines 1741) exits through output aperture 1754 as a portion of the output light 1743 of system 1701.

FIG. 18 is a side-view cross-sectional block diagram of a light-recycling light source 1801 that uses hollow reflector 1850 that is inverted relative to reflector 1750 of FIG. 17, wherein LRLS system 1801 is similar to system 1701 set up such that hollow reflector 1750 is inverted to be reflector 1850 with the smaller ellipsoid reflector 1852 is placed nearer the top of FIG. 18 such the output aperture is face 1851 and includes mirror reflector 1849, and the larger ellipsoid reflector 1853 is placed at the bottom of FIG. 18, such that plane 1854 is the input aperture for light from light source 112. The small-angle light (that portion of light emitted upwards from light source 112 between the two dashed lines 1841) exits through output aperture 1851 as a portion of the output light 1843 of system 1801.

FIG. 19 is a block diagram of a vehicle 1901 that includes a light-recycling light source system 1910, according to some embodiments of the present invention. In some embodiments, system 1910 includes light-recycling light source 1911 that outputs a headlight beam 1943. In some embodiments, signals 1994 are received by sensor 1995 and processed to signals 1996 that are coupled to controller 1990 that controls light-recycling light source 1911. In some embodiments, light-recycling light source 1911 includes one or more of the light sources described herein in order to take advantage of the light recycling of the present invention to improve headlight beam 1943.

In some embodiments, the present invention provides a first light-recycling apparatus that includes a first transparent solid body having an input face, an output face opposite the input face, and a first elliptical side surface that exhibits total internal reflection (TIR) with respect to light incident from a light source at certain angles, wherein the first elliptical side surface defines a first focus point of the first elliptical side surface on the input face and a second focus point of the first elliptical side surface on the output face, such that light that enters the input face at the first focus point and that reflects at a first side of the first elliptical side surface by TIR toward the second focus point, then reflects at second focus point on the output face toward a second side of the first elliptical side surface opposite the first side, and then reflects at the second side of the first elliptical side surface by TIR toward the light source at the first focus point. Some embodiments further include a light source placed immediately next to the first focus point at the input surface of the first transparent solid body, such that light output from the light source is coupled into the first transparent solid body through the input surface, wherein light intersecting the first elliptical side surface is then reflected by the first elliptical side surface through TIR, and is converged toward the second focus point at the output surface where that light is then reflected by the output face through TIR to the opposite side of the first elliptical side surface and then recycled back through TIR and converged toward the first focus point.

In some embodiments of the first light-recycling apparatus (such as shown in FIG. 1), the light source includes a light-emitting diode (LED). In some embodiments of the first light-recycling apparatus (such as shown in FIG. 3 and FIG. 4), the light source includes a plurality of light-emitting diodes (LEDs) including a first LED laterally offset from the first focus point in a first direction, and a second LED laterally offset from the first focus point in a second direction such that light from the first LED is recycled by TIR in the first transparent solid body back toward the first LED and light from the second LED is recycled by TIR in the first transparent solid body back toward the second LED. In some embodiments of the first light-recycling apparatus (such as shown in FIG. 3 and FIG. 4), the light source includes a plurality of at least four light-emitting diodes (LEDs), each emitting light of a different spectral color and arranged in a square grid, the plurality of LEDs including a first LED laterally offset from the first focus point in a first direction, a second LED laterally offset from the first focus point in a second direction, a third LED laterally offset from the first focus point in a third direction, and a fourth LED laterally offset from the first focus point in a fourth direction such that light from each respective one of the first, second, third and fourth LEDs is recycled by TIR in the first transparent solid body back toward the respective one of the first, second, third and fourth LEDs.

In some embodiments of the first light-recycling apparatus, the light source includes a laser and a phosphor material that is located adjacent the first focus point and that is excited by light from the laser to emit wavelength-converted light into the input face of the first transparent solid body. In some embodiments of the first light-recycling apparatus, the light source includes a laser, a motor, and a disc operatively coupled to the motor and configured to be rotated by the motor, wherein the disc includes a phosphor material located on a plurality of areas that are successively rotated to be at a location adjacent the first focus point by rotation of the disc and that are excited by light from the laser at the location adjacent the first focus point to emit wavelength-converted light into the input face of the first transparent solid body.

In some embodiments of the first light-recycling apparatus (such as shown in FIG. 1), the input face of the first transparent solid body is a flat plane. In some embodiments of the first light-recycling apparatus, the input face of the first transparent solid body is concave. In some embodiments of the first light-recycling apparatus (such as shown in FIG. 9 and FIG. 10), the input face of the first transparent solid body is convex. In some embodiments of the first light-recycling apparatus (such as shown in FIG. 1), the output face of the first transparent solid body is a flat plane. In some embodiments of the first light-recycling apparatus (such as shown in FIGS. 9-15), the output face of the first transparent solid body is convex.

Some embodiments of the first light-recycling apparatus (such as shown in FIG. 11) further include a collimating lens having a planar face separated from the output face of the first transparent solid body by an air gap sufficient to permit TIR of recycled light at the output face of the first transparent solid body, the collimating lens further including a convex face opposite the planar face.

In some embodiments of the first light-recycling apparatus (such as shown in FIG. 5 and FIG. 6), the first transparent solid body is formed of a plurality of pieces including an input piece and an output piece that are optically bonded to one another, wherein the output piece has the first elliptical side surface.

In some embodiments of the first light-recycling apparatus (such as shown in FIG. 5 and FIG. 6), the first transparent solid body is formed of a plurality of pieces including an input piece and an output piece that are optically bonded to one another, wherein the output piece has the first elliptical side surface, and wherein the output piece has a larger index of refraction than that of the input piece.

In some embodiments of the first light-recycling apparatus (such as shown in FIGS. 8A, 8B, and 8C), the first transparent solid body is formed of a plurality of pieces including an input piece, an output piece and a goes-before-optics (GOBO) structure that are optically bonded to one another with the GOBO structure between the input piece and the output piece, wherein the output piece has the first elliptical side surface.

In some embodiments of the first light-recycling apparatus (such as shown in FIG. 6), the first transparent solid body further includes a second elliptical side surface that exhibits total internal reflection (TIR) with respect to light incident from a source at certain angles and wherein the second elliptical side surface also defines a first focus point of the second elliptical side surface on the input face and a second focus point of the second elliptical side surface on the output face, such that light that enters the input face at the first focus point and that reflects at a first side of the second elliptical side surface by TIR toward the second focus point exits through the output face.

In some embodiments of the first light-recycling apparatus (such as shown in FIG. 12), the output face of the first transparent solid body is convex and includes a hole extending partially into the first transparent solid body, wherein the hole has a flat bottom that is located at the second focus point of the first elliptical side surface.

In some embodiments of the first light-recycling apparatus (such as shown in FIG. 13), the output face of the first transparent solid body is convex and the elliptical side surface defines the second focus point on a distal portion of the convex output surface.

In some embodiments of the first light-recycling apparatus (such as shown in FIG. 2), the first transparent solid body includes a reflective coating deposited to cover at least a portion of the first elliptical surface that does not support TIR.

In some embodiments of the first light-recycling apparatus (such as shown in FIG. 14), the first transparent solid body includes a reflective coating deposited to cover a central portion of the output face such that light reflected by TIR at the first elliptical surface that impinges the second focus point at non-TIR angles reflects back to an opposite side point of the first elliptical surface and then reflects back toward the first focus point by TIR at the opposite side point.

In some embodiments of the first light-recycling apparatus (such as shown in FIG. 13), the output face of the first transparent solid body is convex and wherein a distal end of the convex output face is located at the second focus point of the first elliptical side surface.

Some embodiments of the first light-recycling apparatus (such as shown in FIG. 19) further include a vehicle, wherein the first transparent solid body and the light source form a portion of a headlight of the vehicle. Some embodiments (not shown) of the any of the light-recycling apparatus described herein further include a spotlight system, wherein the first transparent solid body and the light source form a portion of the spotlight system. Some embodiments (not shown) of the any of the light-recycling apparatus described herein further include a light-projector system, wherein the first transparent solid body and the light source form a portion of the light-projector system.

In some embodiments, the present invention provides a second light-recycling apparatus (such as shown in FIG. 14 and FIG. 15) that includes a first hollow body having an input opening, an output face opposite the input opening, and a highly reflective first elliptical side surface, wherein the first elliptical side surface defines a first focus point at the input opening and a second focus point on the output face, wherein the output face includes a mirror at the second focus point such that light that enters the input opening at the first focus point and that reflects at a first side of the first elliptical side surface toward the second focus point, then reflects at second focus point on the output face toward a second side of the first elliptical side surface opposite the first side, and then reflects at the second side of the first elliptical side surface toward the first focus point.

In some embodiments of the second light-recycling apparatus (such as shown in FIG. 14), the mirror at the second focus point has a flat surface such that light that enters the input opening at the first focus point and that reflects at a first side of the first elliptical side surface toward the second focus point then reflects from the flat surface at the second focus point on the output face toward a second side of the first elliptical side surface opposite the first side, and then reflects at the second side of the first elliptical side surface toward the at the first focus point.

In some embodiments of the second light-recycling apparatus (such as shown in FIG. 15), the mirror at the second focus point has a hemispherical surface such that light that enters the input opening at the first focus point and that reflects at a first side of the first elliptical side surface toward the second focus point then reflects from the hemispherical surface at the second focus point on the output face toward the first side of the first elliptical side surface, and then reflects at the first side of the first elliptical side surface toward the at the first focus point.

Some embodiments of the second light-recycling apparatus (such as shown in FIG. 17 and FIG. 18) further include a second elliptical side surface, wherein the second elliptical side surface is a different ellipsoid that defines its first focus point at the input opening coincident with the first focus point of the first elliptical side surface and its second focus point on the output face coincident with the second focus point of the first elliptical side surface.

In some embodiments, the present invention provides a third light-recycling apparatus (such as shown in some embodiments of FIG. 1, etc.) that includes a first transparent solid body (lens) having an input face, an output face opposite the input face, and a first parabolic side surface that exhibits total internal reflection (TIR) with respect to light incident from a source at certain angles, wherein the first parabolic side surface defines a first focus point of the first parabolic side surface on the output face, such that light that enters the input face at a first central area and that reflects at a first side of the first parabolic side surface by TIR toward the first focus point, then reflects at first focus point on the output face by TIR toward a second side of the first parabolic side surface opposite the first side, and then reflects at the second side of the first parabolic side surface by TIR toward the first central area of the input face.

Some embodiments of the third apparatus further include a light source placed immediately next to the first central area of the input surface of the first lens, wherein the bottom surface is a first focus of the parabolic side surface, such that light output from the light source is coupled into the first lens through the convex bottom surface into the first lens, wherein the light is then reflected by the parabolic surface through TIR, and is converged to a second focus of the parabolic side surface wherein the second focus is at the top convex surface.

In some embodiments of the third apparatus, the light source includes a light-emitting diode (LED). In some embodiments of the third apparatus, the light source includes a plurality of light-emitting diodes (LEDs) including a first LED laterally offset from the first focus point in a first direction, and a second LED laterally offset from the first focus point in a second direction such that light from the first LED is recycled by TIR in the first lens back toward the first LED and light from the second LED is recycled by TIR in the first lens back toward the second LED.

In some embodiments, the present invention provides a first light-recycling method that includes providing a first transparent solid body having an input face, an output face opposite the input face, and a first elliptical side surface that exhibits total internal reflection (TIR) with respect to light incident from a source at certain angles, wherein the first elliptical side surface defines a first focus point on the input face and a second focus point on the output face; inputting light through the input face at the first focus point, reflecting a portion of the input light at a first side of the first elliptical side surface by TIR toward the second focus point, reflecting that light at second focus point on the output face toward a second side of the first elliptical side surface opposite the first side, and reflecting that light at the second side of the first elliptical side surface by TIR toward the first focus point. Some embodiments further include providing a light source, placing the light source immediately next to the first focus point at the input surface of the first transparent solid body, such that light output from the light source is coupled into the first transparent solid body through the input surface.

In some embodiments of the first light-recycling method (such as described for FIG. 1), the light source includes a light-emitting diode (LED).

In some embodiments of the first light-recycling method (such as described for FIG. 3 and FIG. 4), the light source includes a plurality of light-emitting diodes (LEDs) including a first LED laterally offset from the first focus point in a first direction, and a second LED laterally offset from the first focus point in a second direction such that light from the first LED is recycled by TIR in the first transparent solid body back toward the first LED and light from the second LED is recycled by TIR in the first transparent solid body back toward the second LED.

In some embodiments of the first light-recycling method (such as described for FIG. 3 and FIG. 4), the light source includes a plurality of at least four light-emitting diodes (LEDs), each emitting light of a different spectral color and arranged in a square grid, the plurality of LEDs including a first LED laterally offset from the first focus point in a first direction, a second LED laterally offset from the first focus point in a second direction, a third LED laterally offset from the first focus point in a third direction, and a fourth LED laterally offset from the first focus point in a fourth direction such that light from each respective one of the first, second, third and fourth LEDs is recycled by TIR in the first transparent solid body back toward the respective one of the first, second, third and fourth LEDs.

In some embodiments of the first light-recycling method, the light source includes a laser and a phosphor material that is located adjacent the first focus point and that is excited by light from the laser to emit wavelength-converted light into the input face of the first transparent solid body.

In some embodiments of the first light-recycling method, the light source includes a laser, a motor, and a disc operatively coupled to the motor, wherein the method includes rotating the disc by the motor, wherein the disc includes a phosphor material located on a plurality of areas that are successively rotated to be at a location adjacent the first focus point by the rotating of the disc and that are excited by light from the laser at the location adjacent the first focus point to emit wavelength-converted light into the input face of the first transparent solid body.

In some embodiments of the first light-recycling method (such as described for FIG. 1), the input face of the first transparent solid body is a flat plane. In some embodiments of the first light-recycling method, the input face of the first transparent solid body is concave. In some embodiments of the first light-recycling method (such as described for FIG. 9 and FIG. 10), the input face of the first transparent solid body is convex. In some embodiments of the first light-recycling method (such as described for FIG. 1), the output face of the first transparent solid body is a flat plane. In some embodiments of the first light-recycling method (such as described for FIGS. 9-15), the output face of the first transparent solid body is convex.

Some embodiments of the first light-recycling method (such as described for FIG. 11) further include a collimating lens having a planar face separated from the output face of the first transparent solid body by an air gap sufficient to permit TIR of recycled light at the output face of the first transparent solid body, the collimating lens further including a convex face opposite the planar face.

In some embodiments of the first light-recycling method (such as described for FIG. 5 and FIG. 6), the first transparent solid body is formed of a plurality of pieces including an input piece and an output piece that are optically bonded to one another, wherein the output piece has the first elliptical side surface.

In some embodiments of the first light-recycling method (such as described for FIG. 5 and FIG. 6), the first transparent solid body is formed of a plurality of pieces including an input piece and an output piece and the method includes optically bonding the plurality of pieces to one another, wherein the output piece has the first elliptical side surface, and wherein the output piece has a larger index of refraction than that of the input piece.

In some embodiments of the first light-recycling method (such as described for FIGS. 8A, 8B, and 8C), the first transparent solid body is formed of a plurality of pieces including an input piece, an output piece and a goes-before-optics (GOBO) structure that are optically bonded to one another with the GOBO structure between the input piece and the output piece, wherein the output piece has the first elliptical side surface.

In some embodiments of the first light-recycling method (such as described for FIG. 6), the first transparent solid body further includes a second elliptical side surface that exhibits total internal reflection (TIR) with respect to light incident from a source at certain angles and wherein the second elliptical side surface also defines a first focus point of the second elliptical side surface on the input face and a second focus point of the second elliptical side surface on the output face, such that light that enters the input face at the first focus point and that reflects at a first side of the second elliptical side surface by TIR toward the second focus point exits through the output face.

In some embodiments of the first light-recycling method (such as described for FIG. 12), the output face of the first transparent solid body is convex and includes a hole extending partially into the first transparent solid body, wherein the hole has a flat bottom that is located at the second focus point of the first elliptical side surface.

In some embodiments of the first light-recycling method (such as described for FIG. 13), the output face of the first transparent solid body is convex and the elliptical side surface defines the second focus point on a distal portion of the convex output surface.

In some embodiments of the first light-recycling method (such as described for FIG. 2), the first transparent solid body includes a reflective coating deposited to cover at least a portion of the first elliptical surface that does not support TIR.

In some embodiments of the first light-recycling method (such as described for FIG. 14), the first transparent solid body includes a reflective coating deposited to cover a central portion of the output face such that light reflected by TIR at the first elliptical surface that impinges the second focus point at non-TIR angles reflects back to an opposite side point of the first elliptical surface and then reflects back toward the first focus point by TIR at the opposite side point.

In some embodiments of the first light-recycling method (such as described for FIG. 13), the output face of the first transparent solid body is convex and a distal end of the convex output face is located at the second focus point of the first elliptical side surface.

In some embodiments of each above variations of the first light-recycling method, the first elliptical surface is replaced with a parabolic or with a freeform surface that is designed to focus the recycling light at the first and second focus points.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A light-recycling apparatus comprising:
a first transparent solid body having an input face, an output face opposite the input face, and a first curved side surface that exhibits total internal reflection (TIR) with respect to light incident from a light source at certain angles, wherein the first curved side surface defines a first focus point of the first curved side surface on the input face and a second focus point of the first curved side surface on the output face, such that light that enters the input face at the first focus point and that reflects at a first side of the first curved side surface by TIR toward the second focus point, then reflects at second focus point on the output face toward a second side of the first curved side surface opposite the first side, and then reflects at the second side of the first curved side surface by TIR toward the light source at the first focus point.

2. The light-recycling apparatus of claim 1, wherein the first curved surface has a circularly symmetric elliptical shape.

3. The light-recycling apparatus of claim 2, further comprising:
a light source placed immediately next to the first focus point at the input surface of the first transparent solid body, such that light output from the light source is coupled into the first transparent solid body through the input surface, wherein light intersecting the first elliptical side surface is then reflected by the first elliptical side surface through TIR, and is converged toward the second focus point at the output surface where that light is then reflected by the output face through TIR to the opposite side of the first elliptical side surface and then recycled back and converged toward the first focus point.

4. The light-recycling apparatus of claim 3, wherein the light source includes a light-emitting diode (LED).

5. The light-recycling apparatus of claim 3, wherein the light source includes a plurality of light-emitting diodes (LEDs) including a first LED laterally offset from the first focus point in a first direction, and a second LED laterally offset from the first focus point in a second direction such that light from the first LED is recycled by TIR in the first transparent solid body back toward the first LED and light from the second LED is recycled by TIR in the first transparent solid body back toward the second LED.

6. The light-recycling apparatus of claim 3, wherein the light source includes a plurality of at least four light-emitting diodes (LEDs), each emitting light of a different spectral color and arranged in a square grid, the plurality of LEDs including a first LED laterally offset from the first focus point in a first direction, a second LED laterally offset from the first focus point in a second direction, a third LED laterally offset from the first focus point in a third direction, and a fourth LED laterally offset from the first focus point in a fourth direction such that light from each respective one of the first, second, third and fourth LEDs is recycled by TIR in the first transparent solid body back toward the respective one of the first, second, third and fourth LEDs.

7. The light-recycling apparatus of claim 3, wherein the light source includes:
a laser; and
a phosphor that is located adjacent the first focus point and that is excited by light from the laser to emit wavelength-converted light into the input face of the first transparent solid body.

8. The light-recycling apparatus of claim 3, wherein the light source includes:
a laser;
a motor, and
a disc operatively coupled to the motor and configured to be rotated by the motor, wherein the disc includes a phosphor material located on a plurality of areas that are successively rotated to be at a location adjacent the first focus point by rotation of the disc and that are excited by light from the laser at the location adjacent the first focus point to emit wavelength-converted light into the input face of the first transparent solid body.

9. The light-recycling apparatus of claim 1, wherein the input face of the first transparent solid body is a flat plane.

10. The light-recycling apparatus of claim 1, wherein the input face of the first transparent solid body is concave.

11. The light-recycling apparatus of claim 1, wherein the input face of the first transparent solid body is convex.

12. The light-recycling apparatus of claim 1, wherein the output face of the first transparent solid body is a flat plane.

13. The light-recycling apparatus of claim 1, wherein the output face of the first transparent solid body is convex.

14. The light-recycling apparatus of claim 1, further comprising a collimating lens having a planar face separated from the output face of the first transparent solid body by an air gap sufficient to permit TIR of recycled light at the output face of the first transparent solid body, the collimating lens further including a convex face opposite the planar face.

15. The light-recycling apparatus of claim 1, wherein the first transparent solid body is formed of a plurality of pieces including an input piece and an output piece that are optically bonded to one another, wherein the output piece has the first elliptical side surface.

16. The light-recycling apparatus of claim 1, wherein the first transparent solid body is formed of a plurality of pieces including an input piece and an output piece that are optically bonded to one another, wherein the output piece has the first elliptical side surface, and wherein the output piece has a larger index of refraction than that of the input piece.

17. The light-recycling apparatus of claim 1, wherein the first transparent solid body is formed of a plurality of pieces including an input piece, an output piece and a goes-before-optics (GOBO) structure that are optically bonded to one another with the GOBO structure between the input piece and the output piece, wherein the output piece has the first elliptical side surface.

18. The light-recycling apparatus of claim 2, wherein the first transparent solid body further includes a second elliptical side surface that exhibits total internal reflection (TIR) and wherein the second elliptical side surface also defines a first focus point of the second elliptical side surface on the input face and a second focus point of the second elliptical side surface on the output face, such that light that enters the input face at the first focus point and that reflects at a first side of the second elliptical side surface by TIR toward the second focus point exits through the output face.

19. The light-recycling apparatus of claim 1, wherein the output face of the first transparent solid body is convex and includes a hole extending partially into the first transparent solid body, wherein the hole has a flat bottom that is located at the second focus point of the first elliptical side surface.

20. The light-recycling apparatus of claim 1, wherein the first transparent solid body includes a reflective coating deposited to cover at least a portion of the first elliptical surface that does not support TIR.

21. The light-recycling apparatus of claim 1, wherein the first transparent solid body includes a reflective coating deposited to cover a central portion of the output face such that light reflected by TIR at the first elliptical surface that impinges the second focus point at non-TIR angles reflects back to an opposite side point of the first elliptical surface and then reflects back toward the first focus point by TIR at the opposite side point.

22. The light-recycling apparatus of claim 1, wherein the output face of the first transparent solid body is convex and wherein a distal end of the convex output face is located at the second focus point of the first elliptical side surface.

23. The light-recycling apparatus of claim 3, further comprising a vehicle, wherein the first transparent solid body and the light source form a portion of a headlight of the vehicle.

24. The light-recycling apparatus of claim 1, wherein the first curved side surface has a circularly symmetric parabolic shape that exhibits total internal reflection (TIR), wherein the first parabolic side surface defines the second focus point on the output face, such that light that enters the input face at a first central area and that reflects at a first side of the first parabolic side surface by TIR toward the second focus point, then reflects at second focus point on the output face by TIR toward a second side of the first parabolic side surface opposite the first side, and then reflects at the second side of the first parabolic side surface by TIR toward the first central area of the input face.

25. The light-recycling apparatus of claim 24, wherein the input face, the output face, or both the input face and the output face are convex.

26. The light-recycling apparatus of claim 24, further comprising:
a light source placed immediately next to the first central area of the input surface of the first transparent solid body, wherein a central portion of the input surface is a first focus of the parabolic side surface, such that light output from the light source is coupled into the first transparent solid body through the convex bottom surface, wherein the light is then reflected by the parabolic surface through TIR, and is converged to a second focus of the parabolic side surface wherein the second focus is at the top convex surface.

27. The light-recycling apparatus of claim 24, further comprising:
a light source placed immediately next to the first focus point at the input surface of the first transparent solid body, such that light output from the light source is coupled into the first transparent solid body through the input surface, wherein light intersecting the first parabolic side surface is then reflected by the first parabolic side surface through TIR, and is converged toward the second focus point at the output surface where that light is then reflected by the output face through TIR to the opposite side of the first parabolic side surface and then recycled back and converged toward the first focus point.

28. The light-recycling apparatus of claim 24, wherein the light source includes a light-emitting diode (LED).

29. The light-recycling apparatus of claim 24, wherein the light source includes a plurality of light-emitting diodes (LEDs) including a first LED laterally offset from the first focus point in a first direction, and a second LED laterally offset from the first focus point in a second direction such that light from the first LED is recycled by TIR in the first transparent solid body back toward the first LED and light from the second LED is recycled by TIR in the first transparent solid body back toward the second LED.

30. A light-recycling apparatus comprising:
a first hollow body having an input opening, an output face opposite the input opening, and a highly reflective first elliptical side surface, wherein the first elliptical side surface defines a first focus point at the input opening and a second focus point on the output face, wherein the output face includes a mirror at the second focus point such that light that enters the input opening at the first focus point and that reflects at a first side of the first elliptical side surface toward the second focus point, then reflects at second focus point on the output face toward a second side of the first elliptical side surface opposite the first side, and then reflects at the second side of the first elliptical side surface toward the first focus point.

31. The light-recycling apparatus of claim 30, wherein the mirror at the second focus point has a flat surface such that light that enters the input opening at the first focus point and that reflects at a first side of the first elliptical side surface toward the second focus point then reflects from the flat surface at the second focus point on the output face toward a second side of the first elliptical side surface opposite the first side, and then reflects at the second side of the first elliptical side surface toward the at the first focus point.

32. The light-recycling apparatus of claim 30, wherein the mirror at the second focus point has a hemispherical surface such that light that enters the input opening at the first focus point and that reflects at a first side of the first elliptical side surface toward the second focus point then reflects from the hemispherical surface at the second focus point on the output face toward the first side of the first elliptical side surface, and then reflects at the first side of the first elliptical side surface toward the at the first focus point.

33. The light-recycling apparatus of claim 30, further comprising: a second elliptical side surface, wherein the second elliptical side surface is a different ellipsoid that defines its first focus point at the input opening coincident with the first focus point of the first elliptical side surface and its second focus point on the output face coincident with the second focus point of the first elliptical side surface.
